(19) United States
(12) Patent Application Publication
(10) Pub. No.: US 2025/0137209 A1
(43) Pub. Date: May 1, 2025

(54) METHODS FOR SECURING A PAVEMENT MARKER

(71) Applicant: PPG Industries Ohio, Inc., Cleveland, OH (US)

(72) Inventor: Scott Williams, Charlestown, IN (US)

(21) Appl. No.: 18/499,312

(22) Filed: Nov. 1, 2023

(51) Int. Cl. E01F 9/512; C08G 69/02; C08L 23/08

(52) U.S. Cl. CPC E01F 9/512; C08G 69/02; C08L 23/0846

(57) ABSTRACT

Disclosed herein are methods for securing a raised pavement marker to a roadway.

### FIELD

The present disclosure relates to methods for securing a raised pavement marker.

### BACKGROUND

A raised pavement marker (sometimes referred to as an “RPM”) is a safety device often used to improve delineation and increase preview times on roadways, particularly under wet and/or night time conditions. Raised pavement markers can provide safety functions on roads, for example, communicating both the travel path for short- and long-range vehicle operation. Raised pavement markers are conventionally affixed to roadways using adherents such as pressure-sensitive adhesive, epoxy, or bitumen. When positioned on a roadway, raised pavement markers are subject to various forces that may cause them to become dislodged from a roadway, such as weather and traffic.

### SUMMARY

The present disclosure is related to methods for securing a raised pavement marker to a roadway comprising: applying a molten thermoplastic composition comprising a polyamide resin to the roadway, a raised pavement marker, or both; and placing the raised pavement marker on the roadway, wherein the thermoplastic composition adheres the raised pavement marker to the roadway.

The present disclosure is further related to a method of securing a raised pavement marker to a roadway comprising: applying a first layer of a molten thermoplastic composition to a recessed region of a substrate, the recessed region of the substrate comprising a recessed marker region; applying a second layer of the thermoplastic composition to the recessed marker region; and placing a raised pavement marker into the recessed marker region after the second layer of the thermoplastic composition.

The present disclosure is related to a method of sealing a roadway joint configured to receive a raised pavement marker comprising cutting a portion of a roadway to form a recessed marker region; applying a molten thermoplastic composition to the roadway such that the thermoplastic composition forms a layer on the recessed region, wherein the recessed region has a first area defined by a first length and a first width, and the thermoplastic composition layer is applied over a second area defined by a second length and a second width; and wherein the second area is greater than the first area.

### BRIEF DESCRIPTION OF FIGURES

FIG. 1 shows an example of a raised pavement marker.

FIG. 2 shows a raised pavement marker positioned on a roadway surface using a conventional adhesive.

FIG. 3 shows a roadway having a recessed marker region.

FIG. 4 shows a roadway having a recessed region with a thermoplastic composition applied thereto.

FIG. 5 shows a portion of a recessed region of a roadway with a raised pavement marker secured to the roadway by a thermoplastic composition.

### DETAILED DESCRIPTION

The present disclosure relates to methods for securing a raised pavement marker to a roadway comprising applying a molten thermoplastic composition to the roadway, the raised pavement marker, or both, and placing the raised pavement marker on the roadway. The thermoplastic composition comprises a polyamide resin. The thermoplastic composition adheres the raised pavement marker to the roadway; upon hardening of the thermoplastic composition, the RPM becomes fixed in place.

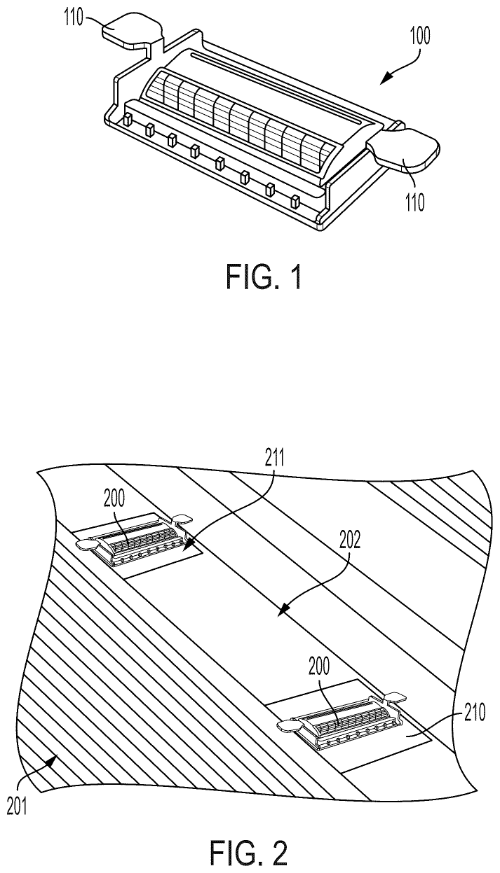

Any RPM can be used according to the present disclosure, such as those commercially available from Ennis-Flint in their STIMSONITE line. The raised pavement markers can include at least one reflective lens or feature that can provide a visual cue for motorists of lane boundaries, road boundaries and the like. An example of a raised pavement marker is shown in FIG. 1. The raised pavement marker 100 shown in FIG. 1 includes two projections 110 that can aid in placement of the raised pavement marker on a roadway. Raised pavement markers can be comprised of various materials known to those in the art, such as a steel or plastic housing that provides a structure for a lens positioned in the housing.

The thermoplastic material used according to the present disclosure comprises a polyamide resin. The thermoplastic material may further comprise one or more of a copolymer, a rosin-modified ester, a modified gum rosin, a pigment, a wax, an antioxidant, a light stabilizer, a plasticizer, and/or an inorganic filler.

The thermoplastic composition described herein may comprise a polyamide resin in an amount of from 2 to 30% (e.g., from 2 to 20%, from 5 to 25%, or from 10 to 20%). The thermoplastic composition may include 2%, 3%, 4%, 5%, 6%, 7%, 8%, 9%, 10%, 12%, 14%, 16%, 18%, 20%, 22%, 24%, 26%, 28%, or 30% polyamide resin. All are expressed in wt. % based on total wt. of the composition. The polyamide resin may comprise at least one of polyolefin elastomers, polypropylene copolymers, styrene-butadiene-styrene (SBS) polymers, and styrene-isoprene-styrene (SIS) polymers.

The thermoplastic composition described herein may also comprise a copolymer in an amount up to 10% (e.g., from 0.2 to 2.5%, from 0.8 to 2.5%, or from 1 to 6%). The thermoplastic composition may include 0.1%, 0.2%, 0.4%, 0.6%, 0.8%, 1%, 1.5%, 2%, 2.5%, 3%, 3.5%, 4%, 4.5%, 5%, 5.5%, 6%, 6.5%, 7%, 7.5%, 8%, 8.5%, 9%, 9.5% or 10% copolymer. All are expressed in wt. % based on total wt. of the composition. The composition may be substantially free of a copolymer, that is, less than 0.2 wt. %. The copolymer may comprise at least one of ethylene vinyl acetate and ethylene maleic anhydride.

The thermoplastic composition described herein may also comprises a rosin-modified ester in an amount up to 40 wt. % (e.g., from 5 to 15%, from 3 to 18%, or 11 to 25%). The thermoplastic composition may include 1%, 2%, 3%, 4% 5%, 6%, 7%, 8%, 9%, 10%, 12%, 14%, 16%, 18%, 20%, 22%, 24%, 26%, 28%, 30%, 32%, 34%, 36%, 38% or 40% rosin-modified ester. All are expressed in wt. % based on total wt. of the composition. The composition may be substantially free of rosin-modified esters, that is, less than 1 wt. %. The modified rosin ester may comprise tall oil esters, maleic rosin ester, pentaerythritol rosin ester, glycerol rosin ester, disproportionated rosin ester, hydrogenated rosin, and/or polymerized rosin.

The thermoplastic composition described herein may comprise a modified gum rosin in an amount up to 40 wt. % (e.g., from 5 to 25%, from 2 to 15%, from 3 to 18%, or from 11 to 25%). The thermoplastic composition may include 1%, 2%, 3%, 4% 5%, 6%, 7%, 8%, 9%, 10%, 12%, 14%, 16%, 18%, 20%, 22%, 24%, 26%, 28%, 30%, 32%, 34%, 36%, 38% or 40% modified gum rosin. All are expressed in wt. % based on total wt. of the composition. The composition may be substantially free of modified gum rosins, that is less than 1 wt. %. The modified gum rosin may comprise glyceryl hydrogenated rosin, rosin modified phenolic resin, pentaerythrityl rosin, glyceryl rosin, disproportionated rosin, polymerized rosin or hydrogenated rosin.

The thermoplastic composition described herein may comprise pigment in an amount of from 0.1 to 10 wt. % (e.g., from 0.2 to 1.2%, 0.5 to 2%, or 2 to 5%). The thermoplastic composition may include 0.1%, 0.2%, 0.3%, 0.4%, 0.5%, 0.6%, 0.7%, 0.8%, 0.9%, 1%, 1.5%, 2%, 2.5%, 3%, 3.5%, 4%, 4.5%, 5%, 5.5%, 6%, 6.5%, 7%, 7.5%, 8%, 8.5%, 9%, 9.5%, or 10% pigment. All are expressed in wt. % based on total wt. of the composition. The pigment may comprise carbon black.

The thermoplastic composition described herein may comprise wax in an amount of up to 20 wt. % (e.g., from 0.5 to 5%, from 1 to 4%, from 1 to 8%, or 5 to 10%). The thermoplastic composition may include 0.5%, 1%, 2%, 3%, 4%, 5%, 6%, 7%, 8%, 9%, 10%, 12%, 14%, 16%, 18%, or 20% wax. All are expressed in wt. % based on total wt. of the composition. In some cases, the wax may comprise polyethylene wax, functionalized PE wax, polypropylene wax, and similar formulations.

The thermoplastic composition described herein may comprise an antioxidant in an amount of up to 3 wt. % (e.g., from 0.1 to 0.4%, from 0.8 to 2%, or 0 to 3%). The thermoplastic composition may include 0.05%, 0.1%, 0.15%, 0.2%, 0.4%, 0.6%, 0.8%, 1%, 1.2%, 1.4%, 1.6%, 1.8%, 2%, 2.2%, 2.4%, 2.5%, 2.6%, 2.7%, 2.8%, 2.9%, or 3% antioxidant. All are expressed in wt. % based on total wt. of the composition. Alternatively, the composition may be substantially free of an antioxidant, that is, less than 0.1 wt. %.

The thermoplastic composition described herein may comprise a light stabilizer in an amount of up to 3.5 wt. % (e.g., from 0.2 to 1.6%, from 0.6 to 2.5%, or 0 to 3%). The thermoplastic composition may include 0.05%, 0.1%, 0.2%, 0.4%, 0.6%, 0.8%, 1%, 1.2%, 1.4%, 1.6%, 1.8%, 2%, 2.2%, 2.4%, 2.6%, 2.8%, 3%, 3.2%, 3.4%, or 3.5% light stabilizer. All are expressed in wt. % based on total wt. of the composition. The composition may be substantially free of a light stabilizer, that is, less than 0.05 wt. %. The light stabilizer may comprise a hindered amine, or hindered amine light stabilizer (HALS).

The thermoplastic composition described herein may comprise a plasticizer in an amount of up to 10 wt. % (e.g., from 1 to 4%, from 1 to 5%, or from 3 to 7%). The thermoplastic composition may include 0.5%, 1%, 1.5%, 2%, 2.5%, 3%, 3.5%, 4%, 4.5%, 5%, 5.5%, 6%, 6.5%, 7%, 7.5%, 8%, 8.5%, 9%, 9.5%, or 10% plasticizer. All are expressed in wt. % based on total wt. of the composition. The plasticizer may comprise one or more of castor oils, other naturally-occurring oils, di-isononyl phthalate, or other phthalates plasticizers.

The thermoplastic composition described herein may comprise an inorganic filler in an amount of from 5 to 90 wt. % (e.g., from 10 to 50%, from 20 to 50%, or from 40 to 60%). The thermoplastic composition may include 5%, 10%, 20%, 25%, 30%, 35%, 40%, 45%, 50%, 55%, 60%, 65%, 70%, 75%, 80%, 85%, or 90% inorganic filler. All are expressed in wt. % based on total wt. of the composition. The inorganic filler may comprise one or more of sand, calcium carbonate, silica, quartzite, marble grit, glass powder, glass cullet, and alumina.

The thermoplastic composition described herein may comprise 3 to 10 wt. % polyamide resin, 0.7 to 3 wt. % copolymer, 5 to 20 wt. % rosin-modified ester, 0.2 to 1.5 wt. % pigment, up to 5 wt. % wax, up to 0.5 wt. % antioxidant, up to 0.7 wt. % light stabilizer, up to 4 wt. % plasticizer, and 20 to 80 wt. % inorganic filler. The thermoplastic composition may comprise 100% solid materials.

The thermoplastic composition described herein may comprise 2 to 20 wt. % polyamide resin, 0 to 5 wt. % copolymer, 3 to 18 wt. % rosin-modified ester, 0 to 10 wt. % modified gum rosin, 0.5 to 4 wt. % ethylene vinyl acetate copolymer, 0.5 to 2 wt. % pigment, 0.5 to 5 wt. % wax, up to 3 wt. % antioxidant, up to 3 wt. % light stabilizer, 1 to 5 wt. % plasticizer, 20 to 50 wt. % of a first inorganic filler, and 20 to 50% of a second inorganic filler. The inorganic filler can comprise sand and/or calcium carbonate.

The thermoplastic composition described herein may comprise 2 to 20 wt. % polyamide resin, 0 to 5 wt. % copolymer, 3 to 18 wt. % rosin-modified ester, 0 to 10 wt. % modified gum rosin, 0.5 to 4 wt. % ethylene vinyl acetate copolymer, 0.5 to 2 wt. % pigment, 0.5 to 5 wt. % wax, up to 3 wt. % antioxidant, up to 3 wt. % light stabilizer, 1 to 5 wt. % plasticizer, 20 to 80 wt. % of an inorganic filler. The inorganic filler can comprise sand and/or calcium carbonate.

The thermoplastic composition described herein may comprise 2 to 20 wt. % polyamide resin, 0 to 5 wt. % copolymer, 3 to 18 wt. % rosin-modified ester, 2 to 15 wt. % modified gum rosin, 0.5 to 4 wt. % ethylene vinyl acetate copolymer, 0.5 to 2 wt. % pigment, 0.5 to 5 wt. % wax, up to 3 wt. % antioxidant, up to 3 wt. % light stabilizer, 1 to 5 wt. % plasticizer, 20 to 50 wt. % of a first inorganic filler, and 20 to 50% of a second inorganic filler. The inorganic filler can comprise sand and/or calcium carbonate.

The thermoplastic composition described herein may comprise 2 to 20 wt. % polyamide resin, 0 to 5 wt. % copolymer, 3 to 18 wt. % rosin-modified ester, 2 to 15 wt. % modified gum rosin, 0.5 to 4 wt. % ethylene vinyl acetate copolymer, 0.5 to 2 wt. % pigment, 0.5 to 5 wt. % wax, up to 3 wt. % antioxidant, up to 3 wt. % light stabilizer, 1 to 5 wt. % plasticizer, 20 to 80 wt. % of an inorganic filler. The inorganic filler can comprise sand and/or calcium carbonate.

The thermoplastic composition may have a viscosity of 1,000 to 50,000 cP, where the viscosity is measured at 425° F. with a Brookfield Viscometer at 6 rpm, #4 or #64 spindle. The thermoplastic composition may have a viscosity of 1,000 to 40,000 cP, where the viscosity is measured at 425° F. with a Brookfield Viscometer at 12 rpm, #4 or #64 spindle. The thermoplastic composition may have a viscosity of 1,000 to 30,000 cP where the viscosity is measured at 425° F. with a Brookfield Viscometer at 30 rpm, #4 or #64 spindle. The thermoplastic composition may have a viscosity of 1,000 to 10,000 cP where the viscosity is measured at 425° F. with a Brookfield Viscometer at 60 rpm, #4 or #64 spindle. In some cases, the thermoplastic composition may have a viscosity of 2,500 to 8,000 cP, 4,000 to 12,000 cP, 5,000 to 16,000 cP, or 7,000 to 22,000 cP where the viscosity is measured at 425° F. with a Brookfield Viscometer at 6 rpm, #4 or #64 spindle.

The thermoplastic material used according to the present disclosure comprises a polyamide resin. Particularly useful thermoplastic materials according to the present disclosure are those described in U.S. Pat. No. 11,118,316, the content of which is incorporated herein. Such compositions are commercially available from Ennis-Flint, in their SEAM SEAL line.

As noted above, the present disclosure is directed to securing a raised pavement marker to a roadway. “Roadway” and like terms, as used herein, refers to any surface or substrate in which RPM may be used, such as roads, sidewalks, parking lots, parking decks, parking blocks, traffic blocks, bollards, ramps, bridges, airport runways, docks, tunnels, sidewalks, parks, and plazas. Typical examples of substrate materials include asphalt, macadam, concrete, and cement.

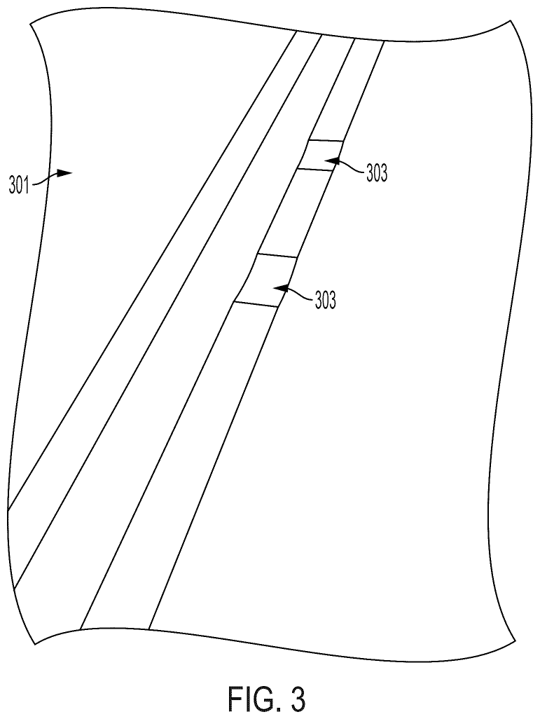

According to the methods of the present disclosure, raised pavement markers may be surface mounted and/or secured in a recessed region of a roadway. The placement of a raised pavement marker in a recessed region of a roadway can minimize the stress on the RPM due to forces applied parallel to the plane of the roadway, such as that from vehicle traffic passing over the RPM or snowplows contacting the marker. FIG. 2 shows an example of two raised pavement markers 200 being placed into a recessed region 202 of a roadway, sometimes referred to herein as a “recessed marker region”. In FIG. 2, the raised pavement markers 200 are secured to the recessed region 202 with a conventional adhesive 210.

For raised pavement markers secured in a recessed area, a portion of a roadway may be cut away by grinding and/or cutting to form a recessed marker region into which the raised pavement marker is placed. FIG. 3 shows a roadway 301 that includes two recessed marker regions 303. Common cuts include rectangular cuts, arcuate cuts, sometimes referred to as a “banana cut,” sinusoidal cuts, and plunge cuts. Any means can be used to create the desired recessed shape in the roadway may be used. Following grinding or cutting away of the roadway, the methods can include a cleaning step that cleans the recessed marker region, for example, to remove any loose pavement. An air compressor or power washer may be suitable for such cleaning of the roadway.

The molten thermoplastic composition can be applied to the roadway, the raised pavement marker, or both according to any means. Particularly suitable is the use of standard thermoplastic extrusion equipment. The extrusion die may be configured to extrude the thermoplastic composition at the desired width directly onto the roadway via a mobile extrusion unit. A thermoplastic composition may be applied using a MRL Mini-Mac with gravity bead system and 12″ ribbon gun, for example.

As used herein, a “molten thermoplastic material” refers to a thermoplastic composition comprising 100% solid materials that become fluid or “melted” when heated. This can be done by equipment at the site of application. The thermoplastic composition may be applied in a variety of forms and can change from molten phase to durable solid phase so that it mechanically adheres to both the roadway and the raised pavement marker when the temperature decreases below the melt temperature of the thermoplastic composition.

As the thermoplastic material hardens, the raised pavement marker becomes secured in the roadway. The surface and ambient air temperatures may vary the time for the thermoplastic composition to harden. The thermoplastic composition may be sufficiently tack-free in approximately 2 minutes, such as when the surface temperature is approximately 50° F. The thermoplastic composition may be sufficiently tack-free in approximately 10 minutes, such as when the surface temperature is approximately 130° F.

The present disclosure is further directed to methods for sealing a roadway joint configured to receive a raised pavement marker where the roadway comprises a recessed marker region into which a raised pavement market may be placed. When a recessed marker region of a substrate is created, a seam or boundary between the recessed marker region and the remaining portion of the roadway is created. Such seams or boundaries can be a point of weakness for the roadway. In some cases, the boundary or seam can provide an interface that may be more susceptible to erosion, cracking, moisture ingress, and other stresses. For example, as tires of a vehicle pass over the seam or boundary, the physical contact can cause erosion of the roadway at the seam due to the uneven surfaces. Thus, sealing the joint with a thermoplastic composition as described herein while also securing the raised pavement marker to the roadway with the same material can in some cases provide dual benefits of providing adding protection to the roadway at the boundaries of the recessed marker region as well as securing the raised pavement marker to the roadway. Because sealing the joint and securing the raised pavement marker can be done with the same material and/or at the same time, this increases efficiency. It can also decrease the likelihood of adhesion failure often experienced between a seam sealing composition and the conventional adhesives used to adhere raised pavement markers.

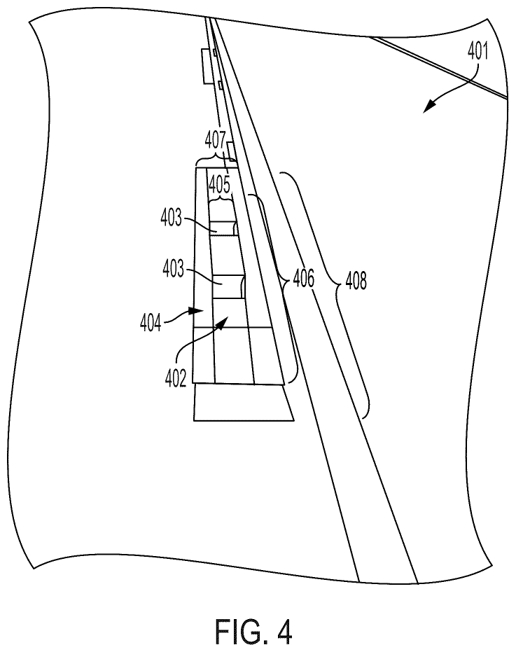

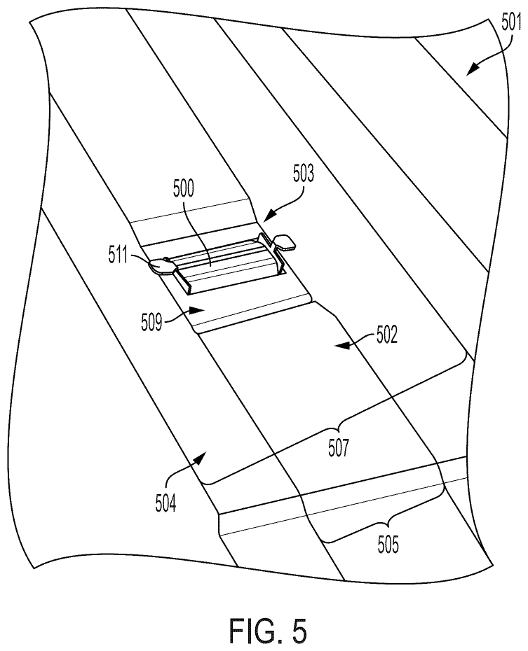

In FIG. 4, the roadway 401 is shown with a recessed region 402. The recessed region 402 has a width 405 and a length 406. The recessed region 402 shown in FIG. 4 comprises two recessed marker regions 403. A thermoplastic composition 404 is applied to the recessed region 402 and applied over an area defined by a width 407 and a length 408. As shown in FIG. 4, the area in which the thermoplastic material 404 is applied is greater than the surface area of the recessed region 402. Such application, where both the width and length of the thermoplastic material layer is greater than those of the width and length of the recessed region, can seal the boundary created as a result of the cutting of the pavement to form the recessed region. The width of the thermoplastic material layer may be greater than the width of the recessed region by more than 3%, for example 4%, 5%, 6%, 7%, 8%, 9%, 10%, 11%, 12%, 13%, 14%, 15%, 20%, 25%, 30% or more. The length of the thermoplastic material layer may be greater than the length of the recessed region by more than 3%, for example 4%, 5%, 6%, 7%, 8%, 9%, 10%, 11%, 12%, 13%, 14%, 15%, 20%, 25%, 30% or more. The thermoplastic material can be applied in a layer having a thickness that is greater than or equal to 40 mils, 60 mils, 80 mils, or 100 mils.

It may be desired to apply more than one layer of the molten thermoplastic composition to the roadway. It may be further desired to apply a first layer, apply an aggregate material to the first layer, and then apply a second layer of molten thermoplastic composition. The application of the aggregate may be performed by dropping the aggregate onto the hot thermoplastic composition. The aggregate may comprise different compositions, for example, those with low free silica. The aggregate may modify the texture of the hardened thermoplastic composition to increase the roughness and provide a safer non-slip surface at the sealed joint. Additionally, the aggregate may modify the visual appearance or reflective properties of the thermoplastic composition, making the composition appear less glossy to an observer.

FIG. 5 shows an enlarged portion of the substrate where a raised pavement marker 500 having projections 511 is secured to the roadway 501 in a recessed marker region 503 via a second application of a thermoplastic material 509. The first application of thermoplastic material 504 is applied as a layer over the recessed region 502 (similar to that shown in FIG. 4). The recessed region 502 has a width 505, and the thermoplastic material is applied to an area having a width 507. As shown in FIG. 5, the width 507 is greater than width 505 such that the thermoplastic layer 504 covers the boundary or interface between the substrate and the recessed region 502.

The methods of the present disclosure can therefore include one or more of the following steps. If it is desired to place the RPM in a recessed marker region of the roadway, and such region does not already exist, the roadway can be cut to create a recessed marker region. The roadway may already have a recessed region formed therein or the RPM may be surface mounted and thus a cutting step is not required. The area to which the RPM may be secured can be cleaned, if desired, which may be particularly suitable if the recessed portion has been cut. A first application of molten thermoplastic composition may be applied to the roadway. The method also optionally includes a step of applying an aggregate to the first application of thermoplastic composition. The method further includes applying a second application of the thermoplastic composition to the desired location of the roadway. Molten thermoplastic can alternatively, or additionally, be placed on the RPM itself. A raised pavement marker can be placed onto or into the desired location, which has the second application of thermoplastic material applied thereto. The methods described herein may include all or some of these steps.

Conventionally, materials such as pressure-sensitive adhesives, epoxies, bitumen, or preformed thermoplastics have been used to adhere raised pavement markers to a surface. Such conventional methods can be cumbersome as they may require precise mixing and careful application of materials and can pose safety risks, for example, those associated with using hot asphalt. Such conventional applications may have lower performance over time as compared to securing a raised pavement marker according to the methods described herein. Conventional epoxy materials can be rigid and, in some cases, degrade the roadway adjacent to the epoxy over time. The present methods provide for use of a flexible material that resists degradation and cracking and may minimize additional stresses to the roadway by pulling the substrate apart. The present methods can secure a raised pavement marker to a roadway and minimize, if not eliminate, fatigue cracking as compared to using conventional adhesive materials. Uses of preformed thermoplastic materials to secure raised pavement markers can be costly and involve too much downtime to secure the raised pavement marker to the roadway.

Any numerical range recited herein is intended to include all sub-ranges subsumed therein. Singular encompasses plural and vice versa. For example, although reference is made herein to “a” thermoplastic, “a” polyamide resin, “a” pigment, and the like, one or more of each of these and any other components can be used. As used herein, the term “polymer” refers to prepolymers, oligomers and both homopolymers and copolymers, and the prefix “poly” refers to two or more. “Polymer” and “resin” may be used interchangeably herein. “Including”, “such as”, “for example” and like terms mean “including/such as/for example but not limited to”, “Roadway”, “pavement” and like terms may be used interchangeably herein. Although the present disclosure is described in terms of “comprising”, the terms “consisting essentially of” and “consisting of” are also within the scope of the disclosure.

The following example is intended to illustrate the disclosure and should not be construed as limited the disclosure in any way.

### Example

First, the roadway was cut and ground to make a recessed marker region. Once the recessed marker region was complete, the recess was cleaned with a towable air compressor to remove any loose pavement. Following cleaning, a MRL Mini-Mac with gravity bead system and a 12″ ribbon gun was used to extrude a 12″ of black thermoplastic onto the recessed marker region. Once the thermoplastic material was applied in a first layer, a second application of the thermoplastic material was applied in the recessed marker region and a raised pavement marker was placed therein. FIGS. 4 and 5 show photographs of the example described herein.

Whereas specific aspects of the disclosure have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of the disclosure which is to be given the full breadth of the claims appended and any and all equivalents thereof.

What is claimed is:

1. A method for securing a raised pavement marker to a roadway comprising:
applying a molten thermoplastic composition comprising a polyamide resin to the roadway, a raised pavement marker, or both; and
placing the raised pavement marker on the roadway, wherein the thermoplastic composition adheres the raised pavement marker to the roadway.

2. The method of claim 1, wherein the thermoplastic composition further comprises one or more of a copolymer, a rosin-modified ester, a modified gum rosin, a pigment, a wax, an antioxidant, a light stabilizer, a plasticizer, and/or an inorganic filler.

3. The method of claim 1, wherein the roadway comprises a recessed marker region into which the raised pavement marker is placed.

4. The method of claim 3, wherein the thermoplastic composition is applied in the recessed marker region prior to the placing of the raised pavement marker.

5. The method of claim 1, wherein the thermoplastic composition is applied after heating the thermoplastic composition to 340° F. to 450° F.

6. The method of claim 1, wherein the roadway is cut and/or cleaned prior to the placing of the raised pavement marker.

7. A method of securing a raised pavement marker to a roadway comprising:
applying a first layer of a molten thermoplastic composition to a recessed marker region of a substrate;
applying a second layer of the molten thermoplastic composition to the recessed marker region; and
placing a raised pavement marker into the recessed marker region after the second layer of the thermoplastic composition.

8. The method of claim 7, further comprising, prior to applying the first layer of thermoplastic composition, cutting the roadway to create the recessed marker region, and optionally, cleaning the recessed marker region.

9. The method of claim 7, comprising applying an aggregate to the first thermoplastic layer prior to applying the second thermoplastic layer.

10. A method of sealing a roadway joint configured to receive a raised pavement marker comprising:
cutting a portion of a roadway to form a recessed marker region;
applying a molten thermoplastic composition to the roadway such that the thermoplastic composition forms a layer on the recessed region, wherein the recessed region has a first area defined by a first length and a first width, and the thermoplastic composition layer is applied over a second area defined by a second length and a second width; and wherein the second area is greater than the first area.

11. The method of claim 10, further comprising optionally applying an aggregate to the layer of the thermoplastic composition, applying a second application of the thermoplastic composition to the raised marker region, the raised pavement marker, or both, and placing a raised pavement marker in the raised marker region.

12. The method of claim 1, wherein the thermoplastic composition comprises:
2 to 30 wt. % polyamide resin;
up to 40 wt % modified rosin ester;
up to 40 wt % modified gum rosin;
0.1 to 10 wt. % pigment;
up to 20 wt. % wax;
less than 10 wt. % plasticizer; and
5 to 90 wt. % of at least one inorganic filler,
where wt. % is based on the total weight of the composition.

13. The method of claim 7, where the thermoplastic composition comprises:
2 to 30 wt. % polyamide resin;
up to 40 wt % modified rosin ester;
up to 40 wt % modified gum rosin;
0.1 to 10 wt. % pigment;
up to 20 wt. % wax;
less than 10 wt. % plasticizer; and
5 to 90 wt. % of at least one inorganic filler,
where wt. % is based on the total weight of the composition.

14. The method of claim 10, where the thermoplastic composition comprises:
2 to 30 wt. % polyamide resin;
up to 40 wt % modified rosin ester;
up to 40 wt % modified gum rosin;
0.1 to 10 wt. % pigment;
up to 20 wt. % wax;
less than 10 wt. % plasticizer; and
5 to 90 wt. % of at least one inorganic filler,
where wt. % is based on the total weight of the composition.

15. The method of claim 1, wherein the thermoplastic composition comprises:
2 to 20 wt. % polyamide resin;
0 to 5 wt. % copolymer;
3 to 18 wt. % rosin-modified ester;
0 to 10 wt. % modified gum rosin;
0.5 to 4 wt. % ethylene vinyl acetate copolymer;
0.5 to 2 wt. % pigment;
0.5 to 5 wt. % wax;
up to 3 wt. % antioxidant;
up to 3 wt. % light stabilizer;
1 to 5 wt. % plasticizer;
20 to 80 wt. % inorganic filler,
where wt. % is based on the total weight of the composition.

16. The method of claim 7, wherein the thermoplastic composition comprises:
2 to 20 wt. % polyamide resin;
0 to 5 wt. % copolymer;
3 to 18 wt. % rosin-modified ester;
0 to 10 wt. % modified gum rosin;
0.5 to 4 wt. % ethylene vinyl acetate copolymer;
0.5 to 2 wt. % pigment;
0.5 to 5 wt. % wax;
up to 3 wt. % antioxidant;
up to 3 wt. % light stabilizer;
1 to 5 wt. % plasticizer;
20 to 80 wt. % inorganic filler,
where wt. % is based on the total weight of the composition.

17. The method of claim 10, wherein the thermoplastic composition comprises:
2 to 20 wt. % polyamide resin;
0 to 5 wt. % copolymer;
3 to 18 wt. % rosin-modified ester;
0 to 10 wt. % modified gum rosin;
0.5 to 4 wt. % ethylene vinyl acetate copolymer;
0.5 to 2 wt. % pigment;
0.5 to 5 wt. % wax;
up to 3 wt. % antioxidant;
up to 3 wt. % light stabilizer;
1 to 5 wt. % plasticizer;
20 to 80 wt. % inorganic filler,
where wt. % is based on the total weight of the composition.
